(19) United States
(12) Patent Application Publication
(10) Pub. No.: US 2018/0153218 A1
(43) Pub. Date: Jun. 7, 2018

(54) VAPORIZER CARTRIDGE SYSTEM

(71) Applicant: VMR Products LLC, Miami, FL (US)

(72) Inventors: Jan Andries VERLEUR, Miami Beach, FL (US); Dan RECIO, Miami Beach, FL (US); Zhiyuan LIU, Miami, FL (US); Hans VERLEUR, El Dorado, CA (US)

(73) Assignee: VMR Products LLC, Miami, FL (US)

(21) Appl. No.: 15/829,466

(22) Filed: Dec. 1, 2017

Related U.S. Application Data
(60) Provisional application No. 62/429,476, filed on Dec. 2, 2016.
(60) Provisional application No. 62/465,381, filed on Mar. 1, 2017.

(51) Int. Cl. A24F 47/00; H05B 3/44

(52) U.S. Cl. CPC A24F 47/008; H05B 3/44

(57) ABSTRACT

A vaporizer for vaporizing flavored liquids is disclosed. The vaporizer includes a mouthpiece, a tank, and an atomizer. The atomizer includes an absorbent pad and a porous bar adjacent a heating element. Liquid flows from the tank onto the absorbent pad and into pores of the porous bar. The heating elements heats the bar, vaporizing the liquid which is then exhausted through the mouthpiece.

### CROSS REFERENCE TO RELATED APPLICATIONS

This application claims the benefit of U.S. Provisional Application Ser. No. 62/429,476, filed Dec. 2, 2016 and U.S. Provisional Application Ser. No. 62/465,381, filed Mar. 1, 2017, the disclosures of each of which are hereby incorporated herein by reference in their entireties.

### BACKGROUND

### 1. Technical Field Text

This disclosure relates generally to vaporizers, which may also be referred to as electronic cigarettes.

### 2. Background Information

Vaporizers have recently emerged as a new product for providing nicotine and other products through a smokeless inhalation process. There are many embodiments of vaporizers including the electronic cigarette. Most implementations consist of a power supply (typically a battery) and an atomizing device. In reusable electronic cigarettes the two items are separated into a battery and a cartomizer, to allow the disposal and replacement of the nicotine containing fluid cartomizer while preserving the more costly battery and associated circuitry (microcontroller, switch, indicating LED, etc.) In disposable electronic cigarettes the two items are combined to integrate the functions into one unit that is disposed of after either the battery energy or the nicotine containing E-liquid is exhausted.

The E-liquid that is used to produce vapor in electronic cigarettes is generally a solution of one or more of propylene glycol (PG) and/or vegetable glycerin (VG) and/or polyethylene glycol 400 (PEG400) mixed with concentrated flavors, and optionally, a variable percentage of a liquid nicotine concentrate. This liquid may be termed an “E-liquid” and is often sold in a bottle or in disposable cartridges or cartomizers. Many different flavors of such E-liquids are sold, including flavors that resemble the taste of regular tobacco, menthol, vanilla, coffee, cola and various fruits. Various nicotine concentrations are also available, and nicotine-free E-Liquids are also common.

### BRIEF SUMMARY

A vaporizer for vaporizing liquids is disclosed. In one aspect, a vaporizer includes an annular tank, a mouth piece, and an atomizer. The annular tank has an outer wall, an inner wall, an annular space defined by an inner surface of the outer wall and an outer surface of the inner wall, and a passageway defined by an inner surface of the inner wall. The mouth piece is coupled to an upper end of the annular tank and has an opening in fluid communication with the passageway. The atomizer is coupled to a lower end of the annular tank and has an absorbent pad in fluid communication with the annular space, a porous ceramic wick in contact with the absorbent pad and in fluid communication with the passageway, and a heating element in contact with the ceramic wick.

In another aspect a vaporizer includes a tank and a reusable atomizer. The tank includes an internal chamber for housing product, a passage through the tank for conveying vapor, and a mouthpiece for outletting the vapor. The reusable atomizer includes a receiver for receiving product, a heater configured to produce vapor from the product, and an outlet for directing vapor from the reusable atomizer. The tank and reusable atomizer are releasably coupled to one another in a configuration aligning the receiver with an outlet of the internal chamber and the outlet with an inlet of the receiver.

In another aspect, a power unit for a vaporizer includes a body, a battery disposed within the body, a printed circuit board disposed within the body, an interface disposed on an outer surface of the body. The interface is in electrical communication with the printed circuit board through spring loaded pins.

### BRIEF DESCRIPTION OF THE DRAWINGS

FIG. 1 illustrates an exploded view of an embodiment of a vaporizer.

FIG. 2 illustrates a cross-section of the vaporizer of FIG. 1.

FIG. 3 illustrates a cross-section of an embodiment of a liquid tank.

FIG. 4 illustrates a side view of an embodiment of a mouthpiece and an atomizer.

FIG. 5 illustrates a cross-section of the embodiments of FIG. 4.

FIG. 6 illustrates a perspective, exploded view of the embodiment for the atomizer of FIG. 4.

FIG. 7 illustrates a cross-section of an embodiment of a vaporizer.

FIG. 8 illustrates a cross-section of the embodiment of FIG. 7.

FIG. 9 illustrates a side view of an embodiment of a vaporizer.

FIG. 10 illustrates a top view of an embodiment of a vaporizer.

FIG. 11 illustrates a perspective view of a cross-section of a vaporizer.

FIG. 12 illustrates a top view of a vaporizer with a cover removed.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

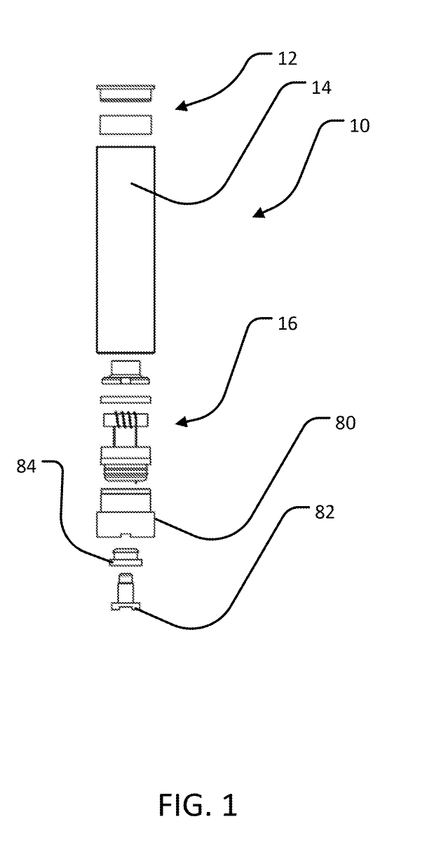

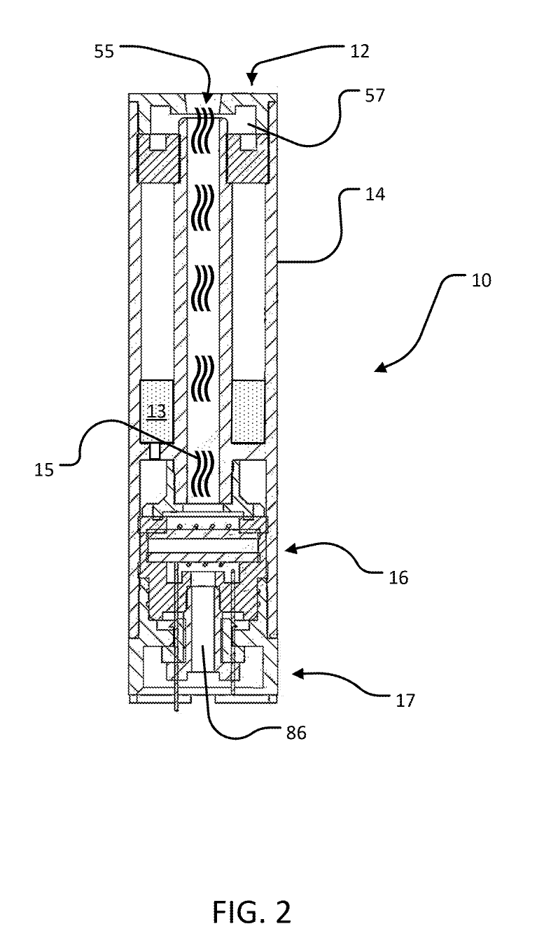

FIG. 1 illustrates an exploded view of an embodiment of a vaporizer 10 and FIG. 2 illustrates a cross-section of the embodiment of FIG. 1. Vaporizer 10 includes a mouthpiece assembly 12, an annular tank 14, an atomizer assembly 16, and a base 17 (FIGS. 1 and 2). In use, E-liquid 13 is stored in annular tank 14, and E-liquid 13 is vaporized in atomizer assembly 16. The vapor 15 resulting from the vaporization of E-liquid 13 passes through annular tank 14 and exhausts through mouthpiece assembly 12.

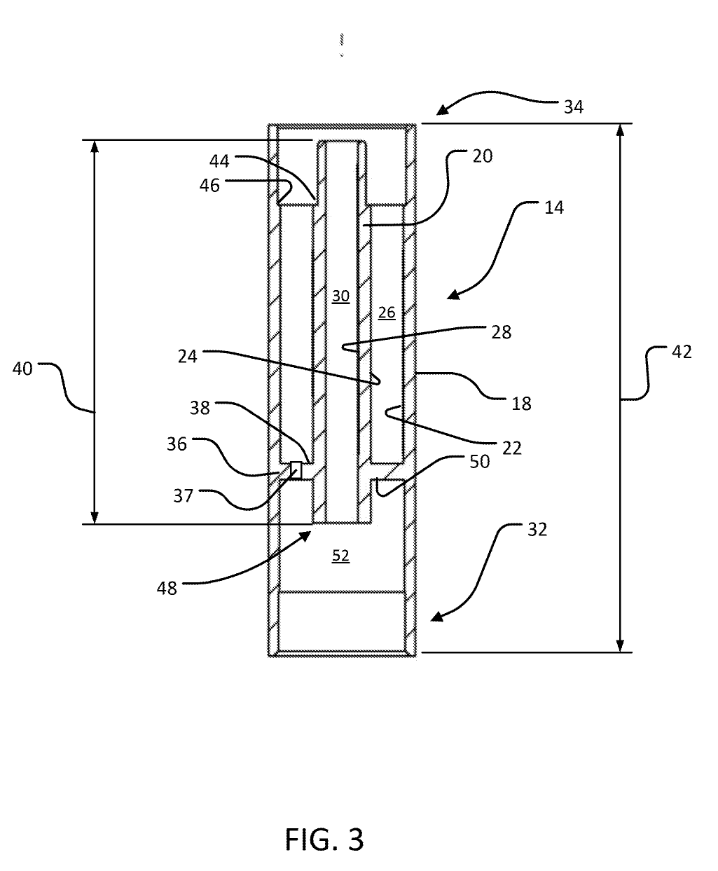

FIG. 3 illustrates a cross-section of annular tank 14 shown individually for clarity. Annular tank 14 has an outer wall 18 and an inner wall 20. An inner surface 22 of outer wall 18 and an outer surface 24 of inner wall 20 partially define an annular space 26 within annular tank 14. An inner surface 28 of inner wall 20 partially defines a passageway 30 from a lower end 32 of annular tank 14 to an upper end 34 of annular tank 14. A web 36 connects inner wall 20 to outer wall 18. An upper surface 38 of web 36 defines a lower boundary of annular space 26. In some embodiments, annular tank 14 may be cylindrical in shape and inner wall 20 and outer wall 18 may each be cylindrical annuluses.

Inner wall 20 has a longitudinal height 40 less than a longitudinal height 42 of outer wall 18. At upper end 34 of annular tank 14, inner wall 20 has a shoulder 44 and outer wall 18 has a similar shoulder 46. At lower end 32, inner wall 20 has an extension 48 that extends past web 36 but less than a distance to lower end 32 of annular tank 14. Inner surface 22 of outer wall 18 and a lower surface 50 of web 38 define a recess 52 in lower end 32 of annular tank 14. Recess 52 may have a threaded connection on inner surface 22 of outer wall 18 for securing components to annular tank 14.

Web 36 has at least one passageway 37 connecting annular space 26 to recess 52 allowing for a flow of E-liquid 13 through web 36. The rate of flow of the E-liquid 13 may be controlled by the cross sectional area of the at least one passageway 37, with a larger cross section allowing for increased E-liquid 13 flow.

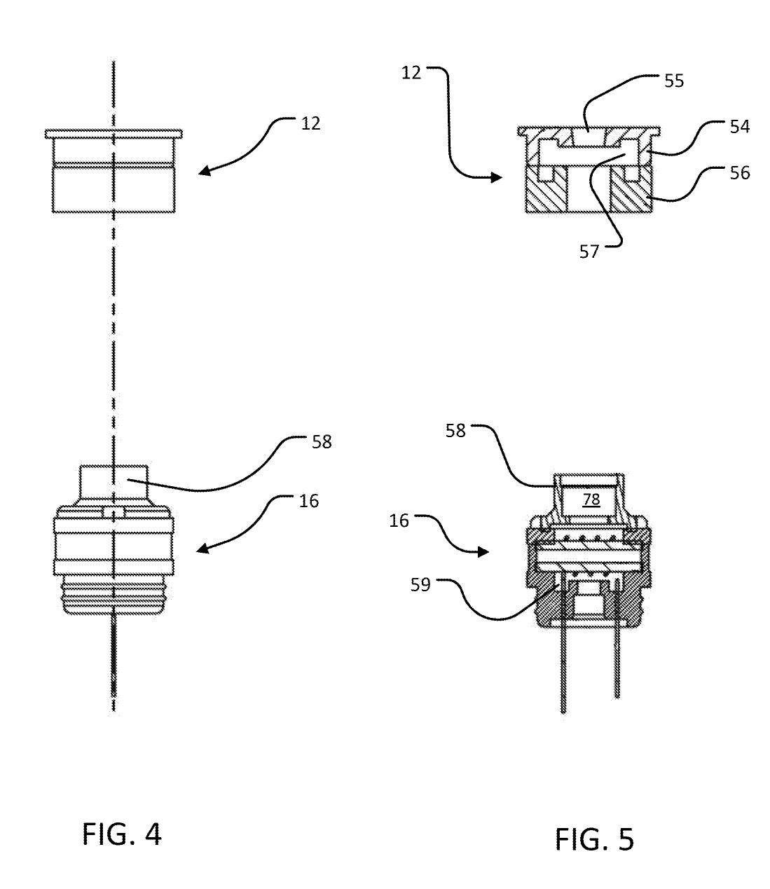

FIG. 4 illustrates a detailed view of mouth piece assembly 12 and atomizer assembly 16. FIG. 5 illustrates a cross-section of mouth piece assembly 12 and atomizer assembly 16. In use, mouth piece assembly 12 is secured within upper end 34 of annular tank 14 and atomizer assembly 16 is secured within lower end 32 of annular tank 14.

Mouth piece assembly 12 has a mouth piece portion 54 and a seal portion 56. The two portions 54, 56 may be permanently joined together, or they may be separable components. Mouth piece assembly 12 may have an external thread for threading into annular tank 14. In some embodiments, mouth piece assembly 12 may be secured within annular tank 14 through a press fit or by way of adhesives. Mouth piece portion 54 may retain the seal portion 56 within annular tank 14 by pressing a lower end of seal portion 56 into shoulders 44, 46 of inner wall 20 and outer wall 18 of annular tank 14.

Mouth piece portion 54 includes a funnel-shaped opening 55 that increases the vapor pressure of the vaporized liquid. Additionally, mouth piece portion 54 includes a groove ring 57 that is sized to receive a collection pad. The collection pad is an absorbent material disposed in the groove ring 57 that collects condensed vapor. Rather than flowing through the funnel shaped opening 55 of mouth piece portion 54, the condensed vapor is retained in the collection pad, reducing leakage of E-liquid 13 through the mouthpiece 12.

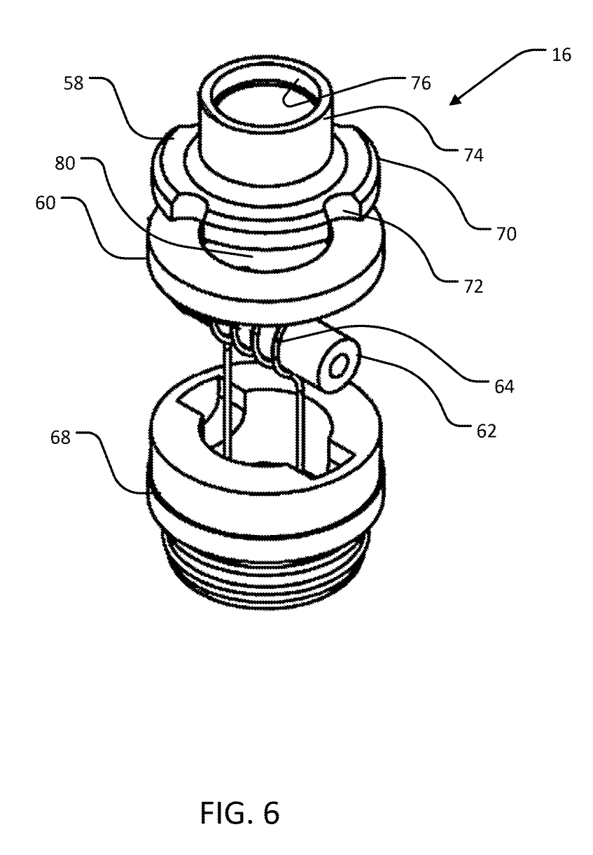

FIG. 6 illustrates a perspective, exploded view of atomizer assembly 16. Atomizer assembly 16 receives E-liquid 13 from annular tank 14 through the at least one passageway 37 of annular space 26, generates vapor 15 from the E-liquid 13, and directs the vapor 15 into passageway 30 of annular tank 14, where it passes through mouthpiece assembly 12 to exit vaporizer 10.

Atomizer assembly 16 includes fixed set 58, absorbent pad 60, porous bar 62, heating coil 64, and support structure 68. Atomizer assembly 16 is positioned within lower end 32 of annular tank 14 and may be secured to the annular tank 14 directly, or in some embodiments may be held in place by base 17.

Fixed set 58 directs the E-liquid 13 from the passageway 37 of rib 50 (FIG. 3) and onto the absorbent pad 60. The E-liquid 13 flows past a base 70 of fixed set 58 by way of cutouts 72 in base 70 of fixed set 58. A protrusion 74 of fixed set 58 has an inner surface 76 that mates with outer surface 24 of inner wall 20, sealing a passageway 78 of fixed set 58 to passageway 30 of annular tank 14.

Absorbent pad 60 is positioned below fixed set 58 and receives the E-liquid 13 as it passes past fixed set 58 through cutouts 72. Absorbent pad 60 absorbs the E-liquid 13 and distributes the E-liquid 13 throughout absorbent pad 60. In some embodiments, absorbent pad 60 may be a cotton pad. Absorbent pad 60 has a central passageway 80 that aligns with passageway 78 of fixed set 58 (FIG. 5), allowing vapor 15 to pass absorbent pad 60.

Porous bar 62 is positioned below absorbent pad 60 and contacts absorbent pad 60. The pores of porous bar 62 wick E-liquid 13 from absorbent pad 60. Porous bar 62 may have an open pore structure, such that the E-liquid 13 is able to travel through the pores. In some embodiments, porous bar 62 may be a microporous ceramic. In some embodiments the pores may be between 0.1 micro meters and 120 micrometers in diameter. The size of the pores may be selected based on the viscosity and surface tension of the E-liquid 13. Thicker E-liquids have a porous bar having a larger pore diameter, while thinner E-liquids may use a smaller pore size.

Porous bar 62 is positioned crosswise, perpendicular to a length (e.g., main axis) of vaporizer 10. A heating element 64 wraps around the porous bar 62. Heating element 64 heats the porous bar 62 to a temperature greater than a boiling point of the E-liquid 13. Because the E-liquid 13 is contained within pores of porous bar 62, it has a large surface area relative to the mass of the E-liquid 13, allowing it to heat and vaporize quickly. The E-liquid 13 expands as it is vaporized and flows through passageway 30 to mouth piece 12.

A support structure 68 supports porous bar 62. Support structure 68 may be made of silicone, such that it has a high temperature resistance and is insulating to both electricity and heat. Support structure 68 is sized to fit within lower end 32 of annular tank 14 and presses fixed set 58 against a lower end of inner wall 20, holding the described elements in place. Additionally, support structure 68 may include a groove ring 59 that is sized to receive a second collection pad. The second collection pad is an absorbent material disposed in the groove ring 59 (FIG. 5) that collects condensed vapor.

Returning to FIG. 1, a base 80 couples to lower end 32 of annular tank 14 and secures support structure 68 in place. In some embodiments, support structure 68 is secured to base 80, which is in turn secured to annular tank 14, holding the components in place. In some embodiments, base 80 is coupled to the lower end 32 of annular tank 14 through a threaded connection or a press fit.

To facilitate an electrical connection to heating element 64, pin 82 may be inserted into base 80 and secured with an insulating bushing 84. Pin 82 may be in electrical communication with a first lead of heating element 64 and isolated with bushing 84 from the base 80. A second lead of the heating element 64 may be in electrical communication with base 80, such that a voltage between base 80 and pin 82 will cause current to flow through heating element 64 causing it to heat. Pin 82 may have a passageway 86 providing an air intake to the vaporizer 10.

Operation of the vaporizer 10 will now be described in relation to FIG. 2. In operation, E-liquid 13 is stored within annular space 26 of annular tank 14. Annular space 26 is sealed, with the exception of at least one passageway 37 through web 36. E-liquid 13 passes through web 36 and past fixed set 58, to at least partially saturate absorbent pad 60. Absorbent pad 60 conveys E-liquid 13 onto porous bar 62, where E-liquid 13 is absorbed. Activation of the heating element 64 causes E-liquid 13 to vaporize to form vapor 15 which passes into passageway 30. As E-liquid 13 vaporizes, it is replaced by additional E-liquid 13 from absorbent pad 60, which is in turn refilled by E-liquid 13 in annular space 26. As E-liquid 13 exits annular space 26, a negative pressure differential develops which reduces the flow between the annular space 26 and the absorbent pad 60. This helps to reduce the possibility of over flooding the absorbent pad 60. This process generally continues until there is no further E-liquid 13 for vaporization.

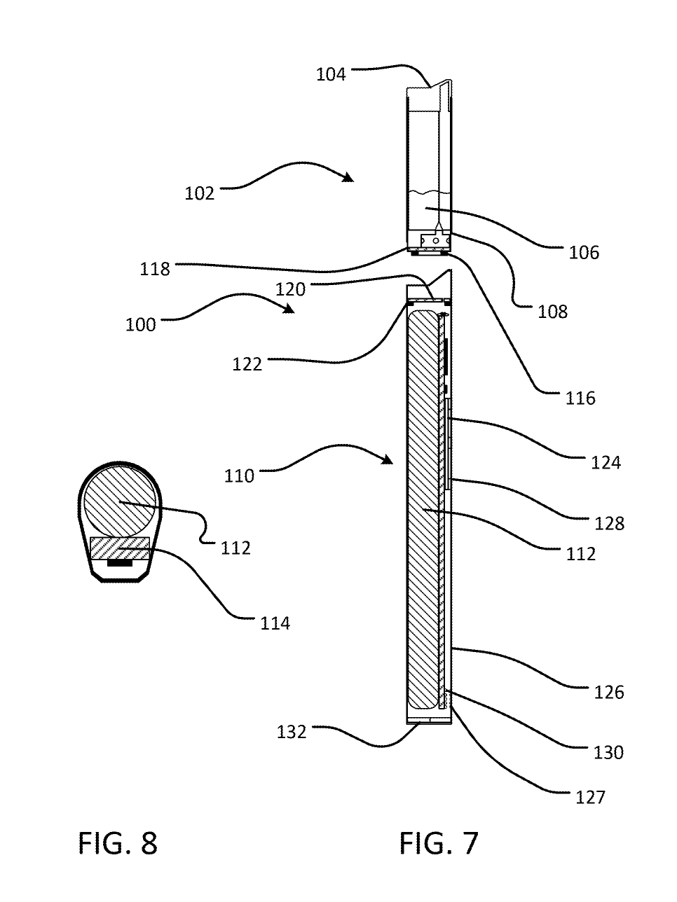

FIG. 7 illustrates a schematic of an embodiment of an electronic cigarette 100. Electronic cigarette 100 includes a cartridge 102 housing a mouthpiece 104, a tank 106, and an atomizer 108, and a power unit 110 housing a battery 112. FIG. 8 illustrates a cross-section of the power unit, showing battery 112 and a printed circuit board 114. In some embodiments, cartridge 102 may be vaporizer 10 as previously described. Tank 106 contains an E-liquid agent that is converted to vapor by the atomizer 108. The vapor exits cartridge 102 through an airflow channel connecting atomizer 108 to mouthpiece 104.

A lower end of the cartridge 102 has a releasable connector for selectively coupling to the power unit 110. In some embodiments, the releasable connector may be a magnet 116. In addition to the magnet 116, cartridge 102 contains a circuit board 118 having circuitry that may control a heating element in the atomizer, or provide an electrical contact for the heating element. The circuit board 118 may have compressible conductive pins such as pogo pins that extend beyond the lower end of the cartridge 102 for connection to an adjacent circuit board 120.

An upper end of power unit 110 includes a releasable connector complementary to the releasable connector of the cartridge 102. In some embodiments, the releasable connector may be a magnet 122. The connector of cartridge 102 and the connector of power unit 110 work together to secure cartridge 102 to power unit 110. Adjacent circuit board 120 may include electrical contacts providing electrical communication with the battery 112. For example, circuit board 120 may have conductive pads having conductive leads interfacing with battery 112. When cartridge 102 and the power unit 110 are secured to one another, the compressible conductive pin of cartridge 102 may be pressed into contact with the conductive pad, electrically coupling power unit 110 to cartridge 102. In some embodiments, power unit 110 may have compressible conductive pins and cartridge 102 may have the conductive pads. Other types of connectors, such as conductive springs are possible and within the scope of the disclosure.

Power unit 110 has an additional circuit board 124 with an interface for interaction with an operator. The interface may include elements such as light emitting diode indicators for output and buttons for receiving operator input. A body 126 of power unit 110 may have a cutout 127 for each of the input/output devices. FIG. 7 illustrates an embodiment including a capacitive touch buttons 128 for functions such as power on and selection of product, and LED indicators 130 near the lower end of power unit 110 to communicate a battery charge status.

Power unit 110 may contain an input for receiving electrical power to charge battery 112. For example, power unit 112 may have a universal serial bus port as a standard input for receiving power. In some embodiments, an inductive charging pad may be located within power unit 110. In the embodiment of FIG. 7, an inductive charging pad 132 is located at the lower end of power unit 110.

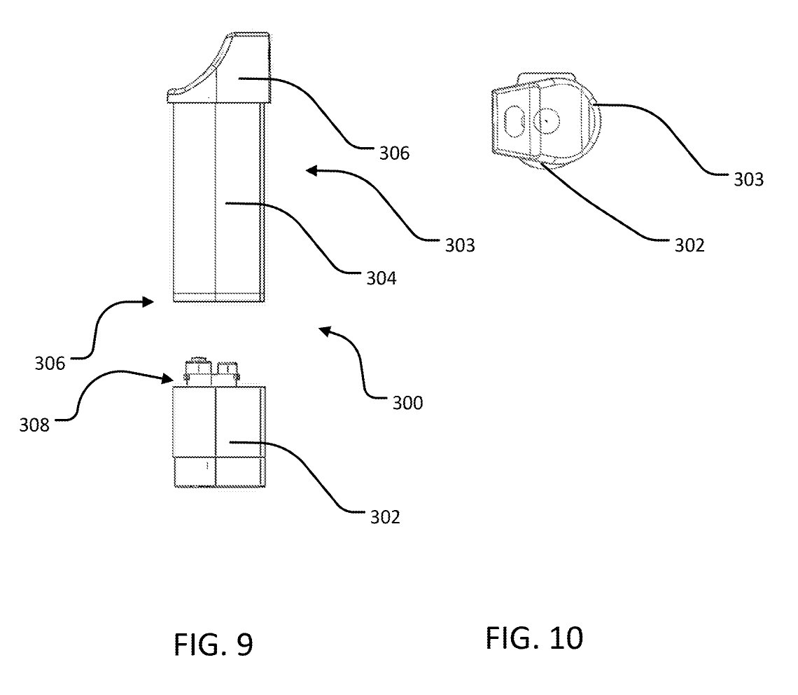

FIG. 9 illustrates a side view of an embodiment of a vaporizer 300 with a reusable atomizer 302. The vaporizer includes reusable atomizer 302 and a disposable portion 303. Disposable portion includes a mouthpiece 306, and a tank 304. The reusable atomizer 302 may have an interface for connecting to a power source, such as a battery. Disposable portion 303 is selectively detachable from reusable atomizer 302. Tank 304 may be pre filled with E-liquid or other product and sealed. The seal may be manually removed by a user or the attachment of disposable portion 303 to reusable atomizer 302 may remove the seal. For example, reusable atomizer 302 may puncture a foil seal of tank 304 when assembled.

FIG. 10 illustrates a top view of vaporizer 300 with disposable portion 303 in position for attachment to reusable atomizer 302. A lower end 306 of disposable portion 303 is placed adjacent an upper end 308 of the reusable atomizer, with the two components being rotationally offset from one another. In the embodiment of FIG. 10 the components are offset by 90 degrees, but other offsets are possible. A rotational movement of the disposable portion relative 303 relative to the reusable atomizer 302 secures the two components together. For example, the two components could have complementary threads, or they could have locking tabs. One of ordinary skill in the art will recognize that other locking mechanisms are possible and locking tabs and threads are only given as possible examples.

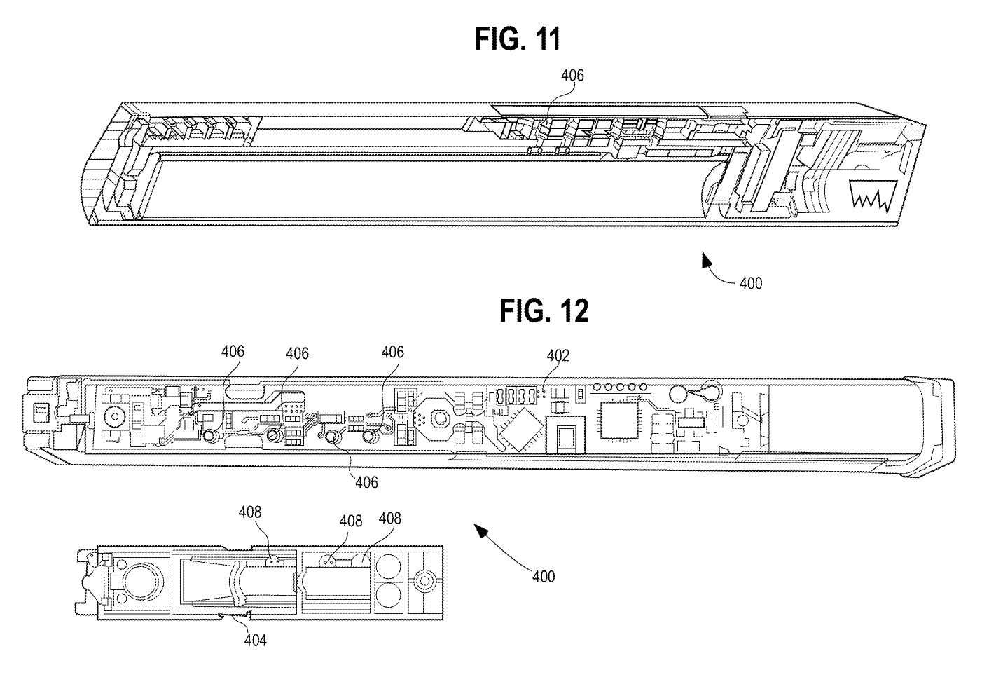

FIG. 11 illustrates a cross-section of an embodiment of a power unit 400 for a vaporizer. FIG. 12 illustrates the power unit 400 of FIG. 11, but with an outer body removed, exposing a circuit board 402. The back of a capacitive touchscreen display 404 is shown next to the power unit 400. The capacitive touch screen display 404 connects to circuit board 402 through the uses of spring loaded pins 406. The spring loaded pins 406 extend through cut outs in the outer body of the power unit, such as cutout 127 of FIG. 7. When the capacitive touch screen display 404 is attached to the power unit 400, the spring loaded pins 406 contact respective conductive pads 408 on the capacitive touch screen display 404. The spring loaded pins 406 and the conductive pads 408 together form an electric connection for transmitting power to and from the capacitive touch screen display 404 from circuit board 402.

The descriptions set forth above are meant to be illustrative and not limiting. Various modifications of the invention, in addition to those described herein, will be apparent to those skilled in the art from the foregoing description. Such modifications are also intended to fall within the scope of the concepts described herein. The disclosures of each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the invention in many other ways, using equivalents and alternatives that do not depart from the scope of the invention. Moreover, unless indicated to the contrary in the preceding description, none of the components described in the implementations are essential to the invention. It is thus intended that the embodiments disclosed in the specification be considered as illustrative, with a true scope and spirit of the invention being indicated by the following claims.

The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

1. A vaporizer, comprising:
an annular tank having an outer wall, an inner wall, an annular space defined by an inner surface of the outer wall and an outer surface of the inner wall, and a passageway defined by an inner surface of the inner wall;
a mouth piece coupled to an upper end of the annular tank, the mouth piece having an opening in fluid communication with the passageway; and
an atomizer assembly coupled to a lower end of the annular tank, the atomizer assembly having an absorbent pad in fluid communication with the annular space, a porous wick in contact with the absorbent pad and in fluid communication with the passageway, and a heating element in contact with the porous wick.

2. The vaporizer according to claim 1, the annular tank further comprising a web connecting the inner wall to the outer wall.

3. The vaporizer according to claim 2, wherein the web has a lower surface and an at least one fluid passageway for fluidly connecting the annular space to the atomizer assembly.

4. The vaporizer according to claim 1, further including a funnel shaped opening.

5. The vaporizer according to claim 1, further including a groove ring for collecting condensed vapor.

6. The vaporizer according to claim 1, wherein the porous wick comprises a porous bar, and the atomizer assembly further comprises a porous bar support structure positioned perpendicularly to a lengthwise axis of the vaporizer.

7. The vaporizer according to claim 6, wherein the porous bar is in proximity to or in contact with the heating element.

8. The vaporizer according to claim 1, further comprising a groove ring and an absorbent collection pad disposed in the groove ring for collecting condensed vapor.

9. The vaporizer according to claim 1, further comprising a power unit, said power unit comprising an outer body, and a circuit board having conductive pads, wherein the vaporizer includes a capacitive touchscreen display in proximity to said circuit board, and the circuit board is electrically connected to the display through the use of spring loaded pins in contact with the conductive pads, and the display is in electrical connection with the power unit.
